(19) United States
(12) Patent Application Publication
(10) Pub. No.: US 2015/0189456 A1
(43) Pub. Date: Jul. 2, 2015

(54) METHOD AND APPARATUS FOR SPECTRUM SENSING OF WIRELESS MICROPHONE SIGNALS

(71) Applicants: Hou-Shin Chen, San Diego, CA (US); Wen Gao, West Windsor, NJ (US)

(72) Inventors: Hou-Shin Chen, San Diego, CA (US); Wen Gao, West Windsor, NJ (US)

(73) Assignee: Thomson Licensing, Issy de Moulineaux (FR)

(21) Appl. No.: 13/980,069

(22) PCT Filed: Jan. 18, 2011
(86) PCT No.: PCT/US2011/000092

§ 371 Date: Jul. 17, 2013

(51) Int. Cl. H04R 29/00; H04R 3/00

(52) U.S. Cl. CPC H04R 29/004; H04R 3/00; H04R 2430/00

(57) ABSTRACT

A method and apparatus for spectrum sensing for general wireless microphone signals are provided. The spectrum sensing algorithm developed makes use of the property that the autocorrelation function of a wireless microphone signal is a sinusoidal function provided that the frequency deviation is much smaller than the carrier frequency and the correlation delay is small. Based on this property, a simple spectrum sensing algorithm for the wireless microphone signal is designed by computing the auto-correlation function of the received signal and matched filtering of the sinusoidal function. The tones detected are further verified to see if they are located at one of the possible wireless microphone frequencies.

### FIELD OF THE INVENTION

The present principles relate to spectrum sensing of general wireless microphone signals and systems.

### BACKGROUND OF THE INVENTION

Cognitive Radio was proposed to implement negotiated, or opportunistic, spectrum sharing to improve spectrum efficiency. Recently, the Federal Communications Commission (FCC) has approved operation of unlicensed radio transmitters in the local broadcast television spectrum at frequencies which are unused by licensed services (this unused TV spectrum is often termed “white space”) under certain rules. A major regulation is that the white space devices will be required to sense, at levels as low as −114 dBm, TV signals (digital and analog), wireless microphone (WM) signals, and signals of other services that operate in the TV bands on an intermittent basis. Hence spectrum sensing is an important enabling technique for the deployment of cognitive radios in TV white space. Note that the noise power in a 6 MHz TV channel under normal temperature is about −96 dBm assuming that the noise figure of a sensing device is 10 dB. Thus, the sensing requirement set by the FCC is about −18 dB in terms of signal-to-noise power ratio (SNR) resulting in a rather difficult task. A uniform framework of spectrum sensing of ATSC/NTSC signals has been proposed in a companion application (PCT/US10/000961) for white space devices.

In the United States, wireless microphones are low-power secondary licensed signals in TV bands and are regulated by FCC Radio Broadcast Rules in Title 47 Code of Federal Regulations (CFR), Part 74 (47 CFR 74). There are four main regulations for wireless microphone usage: (1) The wireless microphones are allowed to operate in unused VHF or UHF TV bands listed in 47 CFR 74 . (2) The frequency selection shall be offset from the upper or lower band limits by 25 kHz or an integral multiple thereof. (3)

One or more adjacent 25 kHz segments within the assignable frequencies may be combined to form a channel whose maximum bandwidth shall not exceed 200 kHz. (4) The maximum transmitter power is 50 mW in VHF bands and 250 mW in UHF bands. In other countries, wireless microphone operations are regulated by different agencies, but with technical characteristics generally similar to those in the United States. The majority of the wireless microphone devices use analog Frequency Modulation (FM) although digital modulation, for example, QAM is sometimes used, or hybrid analog/digital modulations.

Blind spectrum sensing methods, e.g., Eigenvalue-Based algorithms, can be applied to sense a wireless microphone signal regardless of its modulation type. Another method is to look for a spectrum peak in the frequency domain. The bandwidth of wireless microphone signals is less than 200 kHz, much smaller than that of a TV band (6 MHz). As a result, the power of wireless microphone signals is very concentrated while the noise power is uniformly distributed over the whole 6 MHz band. Thus, a spectrum peak usually appears in the spectrum of wireless microphone signals. However, both of the previously mentioned methods produce high false alarm rates when a strong adjacent channel interference is present. The problem of sensing wireless microphone signals with the presence of adjacent channel interference is very difficult. Valid wireless microphone carrier spectrum locations can be located at 237 points within a 6 MHz TV band. The first nominal and last nominal channels are 50 kHz from either of the 6 MHz spectrum edges, with the other nominal channels spaced 25 kHz apart. Since the center frequency of a wireless microphone signal may be only 50 kHz from the adjacent channel edge in the FCC's Adjacent Channel Interference test model, signals around this frequency band are severely affected by the interference leaked from TV signals in the lower adjacent channels. Thus, the wireless microphone signal may be fully shaded by the adjacent channel interference.

Spectrum sensing of FM wireless microphone signals under strong interference is a very challenging task. To address this problem, a simple spectrum sensing method that utilizes an important property of an FM signal, i.e., its autocorrelation function, can be approximated as a sinusoidal function provided that the frequency deviation is much smaller than its carrier frequency and the correlation delay is small (U.S. Ser. No. 10/001467 and U.S. 61/217523). Computer simulations demonstrate that this proposed spectrum sensor can reliably detect the target signals when a strong adjacent channel interference exists and the signal power is as low as −114 dBm, as set by the Federal Communications Commission (FCC) in their reports on so-called white space device.

### SUMMARY OF THE INVENTION

These and other drawbacks and disadvantages of the prior art are addressed by the present principles, which are directed to a method and apparatus for spectrum sensing of general wireless microphone signals.

The principles described herein will focus on sensing of general wireless microphone signals. The autocorrelation based method of detection is extended to sense these digital wireless microphone signals. The autocorrelation based method makes use of the property that the autocorrelation behaves like a sinusoid of carrier frequency when the correlation delay is small. Thus, the proposed spectrum sensor can be seen as a tone detector. However, there are often random tones in the environment which will be picked up by a spectrum sensor and cause a false detection. In order to alleviate the effect of random tones, the principles described herein use a correlation method to verify the tone position and discard it if it is not within a specified frequency range of the nominal frequency of wireless microphone signals.

In this invention, a spectrum sensing method for general wireless microphone signals is described. The proposed method can determine the presence of wireless microphone signals even with strong adjacent channel interference.

According to one aspect of the present principles, there is provided an apparatus for spectrum sensing of wireless microphone signals. The apparatus includes a downconverter that converts a received signal to an intermediate frequency, an analog to digital converter that digitizes the downconverted signal, a processor that generates an autocorrelation function on the digitized received downconverted signal, a decision block that generates a decision statistic on the autocorrelation output, and a comparator that compares the decision statistic to a threshold to determine the presence of a wireless microphone signal.

According to another aspect of the present principles, there is provided a method for spectrum sensing of wireless microphone signals. The method includes the steps of downconverting a received signal, performing analog-to digital conversion on the downconverted signal, computing an autocorrelation function on the digital downconverted received signal, generating a decision statistic on the autocorrelation function output, and comparing the decision statistic to a threshold to determine whether spectrum space is occupied by a wireless microphone signal.

These and other aspects, features and advantages of the present principles will become apparent from the following detailed description of exemplary embodiments, which is to be read in connection with the accompanying drawings.

### BRIEF DESCRIPTION OF THE DRAWINGS

FIG. 1 illustrates a block diagram of one embodiment of the spectrum sensing apparatus for wireless microphone signals using the principles of the present invention.

FIG. 2 shows a flow diagram of one embodiment of the spectrum sensing method for wireless microphone signals using the principles of the present invention.

### DETAILED DESCRIPTION

Spectrum sensing is the term used to describe the process by which white space devices determine whether TV channels are occupied. An approach for spectrum sensing for general wireless microphone signals is described herein. which extends the autocorrelation methods of prior methods to sense general digital wireless microphone signals. The autocorrelation based method makes use of the property that the autocorrelation behaves like a sinusoid of the carrier frequency when the correlation delay is small. The spectrum sensor based on an autocorrelation is therefore seen as a tone detector, which is used to verify a tone position and ignore it, if the tone is not within a specified frequency range of the nominal frequency of digital wireless microphone signals.

When the correlation delay is within a symbol duration, the autocorrelation function of a digital modulated signal, s(t), can be represented as

R_{S}(τ)=E[s(t+τ)s(t)]Q(τ) cos(2πƒ_{c}τ) (1)

where Q(τ) is a decreasing function with respect to r and its value depends on the pulse shaping function used in the transmitter. Furthermore, Q(τ)=0 when τ>Tₛ, where Tₛ is a symbol duration. The parameter ƒ_{c} is the carrier frequency. For a QPSK modulated signal, Tₛ is the duration of a QPSK symbol. For a direct sequence spread spectrum signal, Tₛ is chip duration or the reciprocal of the chip rate. It implies that if we want to use Rₛ(τ) to perform spectrum sensing, the correlation delay τ should not exceed Tₛ. A prior art method by the inventors (U.S. Provisional Application 61/217523) introduced a higher order statistic

$${Z}_{S} ( λ ) = \frac{1}{T} {\int }_{τ = {T}_{D}}^{{T}_{D} + T} {R}_{s} ( τ + λ ) {R}_{s} ( τ ) d τ ≅ A cos ( 2 π {f}_{c} λ ) \qquad ( 2 )$$

where A is a constant depending on signal amplitude. The parameters T_{D} and T are the starting correlation delay and the time interval used to compute Z_{S}(λ), respectively. The higher order statistic is used to alleviate the interference. For FM signals, although Rₛ(τ) does not employ a sinusoid property for a large τ, we may recover the sinusoid property by computing Z_{S}(λ). However, for digital modulated signals, the sinusoid property cannot be recovered by computing Z_{S}(λ) because when τ>Tₛ, Rₛ(τ)=0. Thus, for digital modulated wireless microphone signals, the only way to alleviate interference is to use a longer sensing time to average out the interference. Fortunately, the autocorrelation based sensing methods do not require continuous sensing time. The corresponding spectrum sensor can collect fragmented sensing times to perform sensing. Hence, the length of a quiet period is not a factor which limits the performance of the autocorrelation based sensing methods.

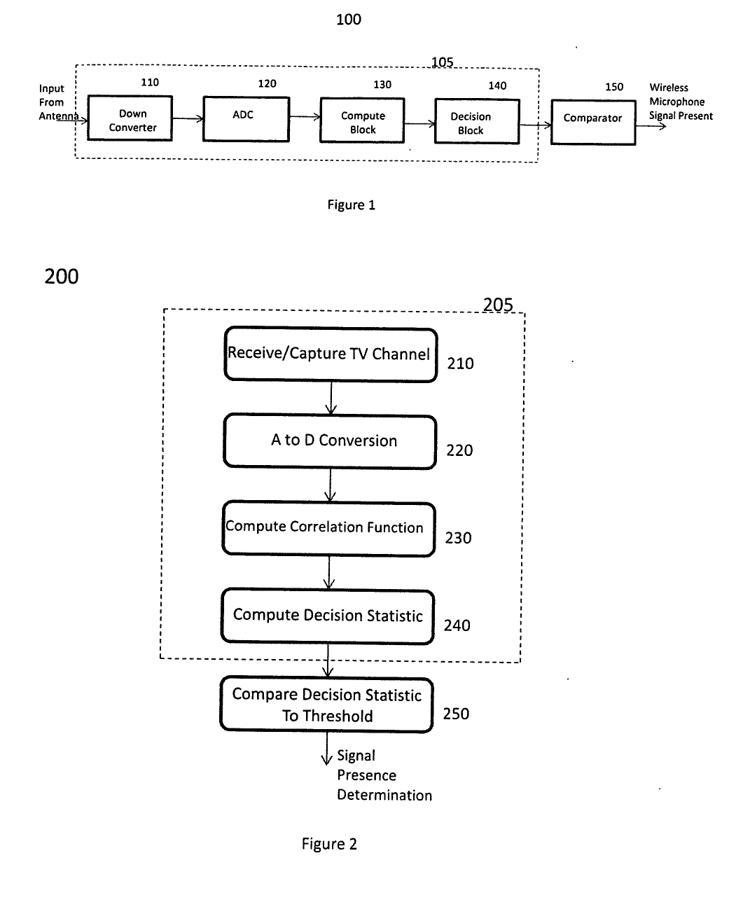

FIG. 1 shows the block diagram of the spectrum sensing apparatus for wireless microphone signals, 100. A signal is received from an antenna and a circuit 105 generates a decision statistic. The decision statistic is compared to a threshold by comparator 150 to determine the presence of a wireless microphone signal. More specifically, one embodiment of circuit 105 is as follows. A TV channel (6 MHz in North America, 8 MHz in Europe) is captured by an RF antenna and frequency down-converted to a proper Intermediate Frequency (IF) in down-converter block 110. The received analog signal y(t) is sampled at a sampling frequency of fₛ by an Analog-to-Digital Converter (ADC) 120, i.e., y[n] =y(n/fₛ) whose input is in signal communication with the output of down-converter 110. The sample autocorrelation function is computed in block 130 by

$${R}_{y} [ m ] = \frac{1}{N} {\sum }_{i = 0}^{N - 1} y [ i + m ] y [ i ] \qquad ( 3 )$$

where N is the number of samples used to compute the sample autocorrelation function. The input of block 130 is in signal communication with the output of Analog-to-Digital Converter 120. Note that the correlation delay, m, should satisfy m<fₛTₛ. If the carrier frequency and pulse shaping function of the wireless microphone signal are known, the optimal detector is a matched filter, i.e., the decision statistic of the optimal detector is given by

T=Σₘ₌₁^{M}R_{y}[m]Q[m] cos(2πƒ_{c}m/ƒₛ) (4)

where M is the number of autocorrelation values used to compute the decision statistic. However, different digital wireless microphone devices in the market may use different pulse shaping functions. Since we do not have the information about the pulse shaping function used for a particular device, we simply set Q[m]=1. Furthermore, the wireless microphone device can select any frequency within a TV channel as its carrier frequency as long as the frequency offsets from the TV channel edge is a multiple of 25 kHz. Assume that the received signal occupies a band from P MHz to (P+B) MHz, where B=6 in the USA. The wireless microphone devices can have f₀=P MHz+50 kHz, f₁=P MHz+75 kHz, . . . f_{N-1}=(P+B) MHz-50 kHz, as its nominal carrier frequencies. There are, in total, N=1+(B MHz−100 kHz)/(25 kHz) possible carrier frequencies in the spectrum space of one TV channel. As a result, the decision statistic of the optimal detector is computed by block 140, whose input is in signal communication with the output of block 130. The decision statistic is given by

T=max_{0≦n≦N-1}Σₘ₌₁R_{y}[m] cos(2πƒₙm/ƒₛ) (5)

When these sensing methods are implemented, there exists the possibility of random tone signals in the environment. These tone signals can enter the system, be detected as a tone, and be mistaken for a wireless microphone signal. To alleviate the effect of these random tones, under the principles of the present invention, the position of the tones picked up by the tone detector is verified to see if it actually is a wireless microphone signal in block 150, whose input is in signal communication with the output of block 140. Let

$$\begin{matrix}{n}^{⋒} = arg {max}_{0 \leq n \leq N - 1} {\sum }_{m = 1}^{M} {R}_{y} [ m ] cos ( 2 π {f}_{n} m / {f}_{s} ) \\ and \\ {T}_{+ 1} = {\sum }_{m = 1}^{M} {R}_{y} [ m ] cos [ 2 π ( {f}_{{n}^{⋒}} + {f}_{Δ} ) m / {f}_{s} ] & ( 6 ) \\ {T}_{- 1} = {\sum }_{m = 1}^{M} {R}_{y} [ m ] cos [ 2 π ( {f}_{{n}^{⋒}} - {f}_{Δ} ) m / {f}_{s} ] . & ( 7 )\end{matrix}$$

where f_{Δ} is chosen to be larger than the frequency offset of the transmitter and receiver with respect to the nominal frequency. Thus, this tone verification method requires frequency precision in both the transmitter and the receiver. If T is greater than both T₊₁ and T₋₁, we conclude that the detected tone is within f_{Δ} kHz of the nominal carrier frequency of wireless microphone signals and that the signal indeed is a wireless microphone signal. If T is not greater than both T₊₁ and T₋₁, we conclude that it is a random tone and discard it. Of course, when the random tone signal is within f_{Δ} kHz of the nominal frequency of wireless microphone signals, false alarms will still happen. However, for example, let f_{Δ}=1 kHz, by further checking the tone position we can remove up to 23/25=92% of the random tone signals.

FIG. 2 illustrates a flow diagram of one embodiment of the spectrum sensing method for wireless microphone signals. In step 205, a signal is received and processing is performed to generate a decision statistic. The decision statistic is compared to a threshold in step 250 to determine if a wireless microphone signal is present. More specifically, one embodiment of step 205 is as follows. A signal representing a TV channel is received and captured in step 210. The received signal is digitized by an analog-to-digital converter in step 220. A correlation function is computed in step 230. A decision statistic is computed in step 240. The result of the decision function is compared to a threshold in step 250 to determine if the found signal is a wireless microphone signal.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

A description will now be given of the many attendant advantages and features of the present principles for detection of general wireless microphone signals, some of which have been mentioned above. For example, one advantage of the present principles is an apparatus for spectrum sensing of general wireless microphone signals comprising a circuit to generate a decision statistic followed by a comparator for comparing the decision statistic with a threshold. A further advantage is the aforementioned apparatus comprising a downconverter for converting a received signal to an intermediate frequency, an analog to digital converter for digitizing the downconverted signal; a processor for generating an autocorrelation function, followed by a decision block for generating a decision statistic, and a comparator for comparing the decision statistic to a threshold to determine the presence of wireless microphone signals within a spectrum space. Another advantage in the previous apparatus is a processor that approximates the autocorrelation function with a function comprising a sinusoidal signal. Yet another advantage in the previously mentioned apparatus is the processor collecting fragmental sensing times in computing the autocorrelation function. Yet another advantage of the previous apparatus is using a matched filter in generating a decision statistic. Another advantage of the present principles is a method for performing spectrum sensing of wireless microphone signals comprising downconverting a received signal, performing analog to digital conversion on the downconverted signal, computing an autocorrelation function, generating a decision statistic, and comparing the decision statistic to a threshold to determine the presence of a wireless microphone signal within a spectrum space. Yet a further advantage is the method just mentioned, wherein the autocorrelation function is approximated with a function comprising a sinusoidal signal. Another advantage is the method previously mentioned wherein fragmental sensing times are collected in computing the autocorrelation function. Yet another advantage of the previously mentioned method is using a matched filter in generating a decision statistic.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

1. An apparatus for spectrum sensing of wireless microphone signals, comprising:
a circuit for generating a decision statistic from a received signal;
a comparator to compare the decision statistic to a threshold to determine the presence of a wireless microphone signal.

2. The apparatus of claim 1, wherein the circuit for generating a decision statistic comprises:
a downconverter for converting a received signal to an intermediate frequency;
an analog to digital converter for digitizing the downconverted signal;
a processor for generating an autocorrelation function on the digitized received downconverted signal;
a decision block for generating a decision statistic on the autocorrelation output.

3. The apparatus of claim 2, wherein the autocorrelation function is approximated with a function comprising a sinusoidal signal.

4. The apparatus of claim 2, wherein the processor collects fragmental sensing times for performing the autocorrelation function.

5. The apparatus of claim 2, wherein the decision block generates the decision statistic using a matched filter.

6. The apparatus of claim 2, wherein:
the autocorrelation function is given by
$${R}_{y} [ m ] = \frac{1}{N} {\sum }_{i = 0}^{N - 1} y [ i + m ] y [ i ]$$
and the decision statistic is given by
T=max_{0≦n≦N-1}Σₘ₌₁^{M}R_{y}[m] cos(2πƒₙm/ƒₛ)

7. A method for spectrum sensing of wireless microphone signals, comprising:
generating a decision statistic on a signal; and
comparing the decision statistic to a threshold to determine spectrum space occupied by a wireless microphone signal.

8. The method of claim 7, wherein the generating step comprises:
downconverting a received signal;
performing analog-to-digital conversion on the downconverted received signal; and
computing an autocorrelation function on the digital downconverted received signal.

9. The method of claim 8, wherein the autocorrelation function is approximated with a function comprising a sinusoidal signal.

10. The method of claim 8, wherein computing an autocorrelation function comprises collecting fragmental sensing times.

11. The method of claim 8, wherein generating a decision statistic is performed using a matched filter.

12. The method of claim 8 wherein:
the autocorrelation function is given by
$${R}_{y} [ m ] = \frac{1}{N} {\sum }_{i = 0}^{N - 1} y [ i + m ] y [ i ]$$
and the decision statistic is given by
T=max_{0≦n≦N-1}Σₘ₌₁^{M}R_{y}[m] cos(2πƒₙm/ƒₛ)
